(19) United States
(12) Patent Application Publication
(10) Pub. No.: US 2008/0263071 A1
(43) Pub. Date: Oct. 23, 2008

(54) SYSTEMS AND METHODS FOR DRIVERLESS IMAGING OF DOCUMENTS

(75) Inventors: Andrew Rodney Ferlitsch, Camas, WA (US); Ronnie Neil Patton, Lake Oswego, OR (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/737,607

(22) Filed: Apr. 19, 2007

(51) Int. Cl. G06F 7/00

(52) U.S. Cl. 707/101; 707/E17.019

(57) ABSTRACT

A method for driverless imaging of documents may include a direct imaging application on a client sending an imaging request message to another device, which may be a direct imaging server or a target imaging device. In response to receiving the imaging request message, the device may create an imaging job skeleton that includes contents of a complete imaging job other than document data. The device may send a despooling request to the direct imaging application. The despooling request may indicate where the document data corresponding to the imaging job should be despooled. In response to receiving the despooling request, the direct imaging application may despool the document data in accordance with the despooling request.

### TECHNICAL FIELD

The present disclosure relates generally to computers and computer-related technology. More specifically, the present disclosure relates to imaging devices and document imaging.

### BACKGROUND

“Imaging,” as the term is used herein, refers to one or more of the processes involved in the display and/or printing of graphics and/or text. The term “imaging device,” as used herein, refers to any electronic device that provides functionality related to imaging. Some examples of imaging devices include multi-function peripheral devices, printers, copiers, scanners, facsimile devices, document servers, image servers, electronic whiteboards, digital cameras, digital projection systems, medical imaging devices, and so forth.

For various reasons, an imaging device may be logically connected to (i.e., placed in electronic communication with) one or more computer systems, which may be referred to as host computer systems (or simply as hosts). For example, a printer may be connected to a network of computer systems. This allows the users of the various computer systems on the network to use the printer.

Different kinds of computer software facilitate the use of imaging devices. The computer system that is used to image (e.g., print) the materials typically has one or more pieces of software that enable it to send information to the imaging device to facilitate the imaging of the materials. If the computer system is on a computer network there may be one or more pieces of software running on one or more computers on the computer network that facilitate the imaging of the materials.

As used herein, the term “imaging job” may refer to an imaging-related task that is performed by an imaging device. An example of an imaging job is a print job, which may be a single document or a set of documents that is submitted to a printer for printing.

As used herein, the term “document” should be interpreted broadly to include any type of file on which one or more imaging-related operations may be performed. A document, as used herein, may include text and/or images.

Some imaging devices support direct rendering a variety of document data in the document's native format (e.g., PDF, TIFF, Microsoft Word, etc.). In this mode, a document whose native format is supported by the imaging device can be directly submitted for rendering (e.g., print, fax, file) without the use of an imaging device driver to convert the document data to a format supported by the imaging device (e.g., page description language (PDL), such as PCL, Postscript, etc.).

Some host side products support the direct submission of native formatted documents (i.e., without an imaging device driver). In some of these products, the user may be able to specify one or more imaging settings. These products are sometimes referred to as direct print (or direct submit) utilities.

### BRIEF DESCRIPTION OF THE DRAWINGS

FIG. 1 illustrates an exemplary operating environment in which embodiments may be practiced;

FIG. 2A illustrates a direct imaging application sending a job information message to a direct imaging server;

FIG. 2B illustrates a direct imaging application receiving a settings user interface definition from a direct imaging server;

FIG. 2C illustrates a direct imaging application sending an imaging request message to a direct imaging server;

FIG. 3A illustrates a direct imaging server sending a despooling request message to a direct imaging application where the format of the document data is not supported by the target imaging device(s);

FIG. 3B illustrates a conversion device converting document data;

FIG. 4A illustrates a direct imaging server sending a despooling request message to a direct imaging application where the format of the document data is supported by the target imaging device(s);

FIG. 4B illustrates a direct imaging application despooling a complete imaging job to an imaging device; and

FIG. 5 illustrates various components that may be utilized in a computing device.

### DETAILED DESCRIPTION

A method for driverless imaging of documents is disclosed. A direct imaging application on a client may send an imaging request message to another device. The imaging request message may correspond to an imaging job to be performed on a target imaging device. In response to receiving the imaging request message, the device may create an imaging job skeleton. The imaging job skeleton may be compatible with the target imaging device. The imaging job skeleton may include contents of a complete imaging job other than document data. The device may send a despooling request to the direct imaging application. The despooling request may indicate where the document data corresponding to the imaging job should be despooled. In response to receiving the despooling request, the direct imaging application may despool the document data in accordance with the despooling request.

The device that creates the imaging job skeleton and that sends the despooling request may be a direct imaging server. The device that creates the imaging job skeleton and that sends the despooling request may be the target imaging device.

The despooling request may include the imaging job skeleton. In this situation, the direct imaging application may merge the document data into the imaging job skeleton.

If the format of the document data is native to the target imaging device, the despooling request may indicate that the document data should be despooled to the target imaging device. If the format of the document data is not native to the target imaging device, the despooling request may indicate that the document data should be despooled to a conversion device. The conversion device may be a direct imaging server. Alternatively, the conversion device may be another device other than a direct imaging server.

The conversion device may convert the document data into a format that is compatible with the target imaging device. The conversion device may despool the converted document data to the target imaging device.

The direct imaging application may receive user selections of imaging settings for the imaging job via a settings user interface. The imaging request message may include the imaging settings. In this situation, creating the imaging job skeleton may involve converting the imaging settings in the imaging request message into command control sequences that are specific to the target imaging device.

The direct imaging application may send a job information message to the device. In response to receiving the job information message, the device may send a settings user interface definition to the direct imaging application. The direct imaging application may generate and display the settings user interface based on the settings user interface definition.

A client device that is configured to effect driverless imaging of documents is also disclosed. The client device includes a processor and memory in electronic communication with the processor. Instructions are stored in the memory. The instructions may be executable to send an imaging request message to another device. The imaging request message may correspond to an imaging job to be performed on a target imaging device. The instructions may also be executable to receive a despooling request from the device. The despooling request may indicate where document data corresponding to the imaging job should be despooled. The instructions may also be executable to, in response to receiving the despooling request, despool the document data in accordance with the despooling request.

The despooling request may include an imaging job skeleton. The imaging job skeleton may be compatible with the target imaging device. The imaging job skeleton may include contents of a complete imaging job other than the document data. The instructions may also be executable to merge the document data into the imaging job skeleton.

If the format of the document data is native to the target imaging device, the despooling request may indicate that the document data should be despooled to the target imaging device. If the format of the document data is not native to the target imaging device, the despooling request may indicate that the document data should be despooled to a conversion device.

A device that is configured to facilitate driverless imaging of documents is also disclosed. The device may include a processor, and memory in electronic communication with the processor. Instructions are stored in the memory. The instructions may be executable to receive an imaging request message from a client. The imaging request message may correspond to an imaging job to be performed on a target imaging device. The instructions may also be executable to, in response to receiving the imaging request message, create an imaging job skeleton. The imaging job skeleton may be compatible with the target imaging device. The imaging job skeleton may include contents of a complete imaging job other than document data. The instructions may also be executable to send a despooling request to the direct imaging application. The despooling request may indicate where the document data corresponding to the imaging job should be despooled.

Several exemplary embodiments are now described with reference to the Figures. This detailed description of several exemplary embodiments, as illustrated in the Figures, is not intended to limit the scope of the claims.

The word “exemplary” is used exclusively herein to mean “serving as an example, instance or illustration.” Any embodiment described as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments,” unless expressly specified otherwise.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

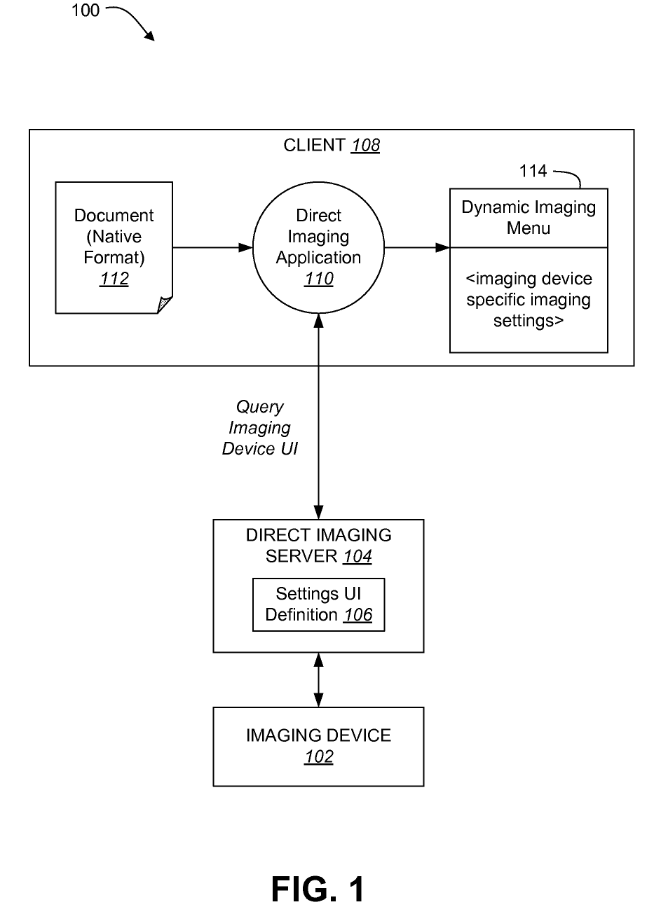

FIG. 1 illustrates an exemplary operating environment 100 in which embodiments may be practiced. An exemplary operating environment 100 may include a client 108 and a network or locally connected imaging device 102 with remote job input capabilities. The imaging device 102 may be a multi-functional peripheral device (MFP). Some examples of remote input jobs include print jobs, scanning jobs (e.g., twain driver), PC-fax jobs, filing jobs, format conversion jobs, etc.

A server 104 is also shown in electronic communication with both the client 108 and the imaging device 102. The server 104 may be referred to herein as a direct imaging server 104. In FIG. 1, the direct imaging server 104 is shown with a settings user interface (UI) definition 106. The settings UI definition 106 may be uploaded to the client 108 upon request. In an alternative embodiment, the settings UI definition 106 may be located on the imaging device 102.

The client 108 shown in FIG. 1 may be a “thin” client 108, i.e., a client 108 in which relatively little processing occurs. The client 108 may not have a driver that corresponds to the imaging device 102. The client 108 may not have one or more applications corresponding to document formats that are supported by the imaging device 102. The client 108 may not have any knowledge of which formats are native to the imaging device 102 and which formats are not native to the imaging device 102.

The client 108 is shown with a direct imaging application 110 that allows the direct submission of one or more documents 112 in native format (e.g., without the use of a driver) to an imaging device 102. (As indicated, the term “document” should be interpreted broadly, and may include text, vectors and/or images.) Additionally, the direct imaging application 110 may be able to request the settings UI definition 106 and render a UI 114 for imaging settings accordingly.

Communication between the direct imaging application 110 and the server 104 (or imaging device 102) for requesting and uploading the settings UI definition 106 may be over any suitable communication channel. Some examples of communication channels that may be used include: TCP/IP, Apple Talk, IEEE 1284 parallel port, IRDA, wireless protocols (e.g., Bluetooth, WiFi, WiMAX), a local port (e.g., serial port, a USB port), etc.

The settings UI definition 106 may be defined in any protocol that is effective in describing how to render a UI 114. For example, the settings UI definition 106 may be defined in HTML, XML, SOAP/XML, etc.

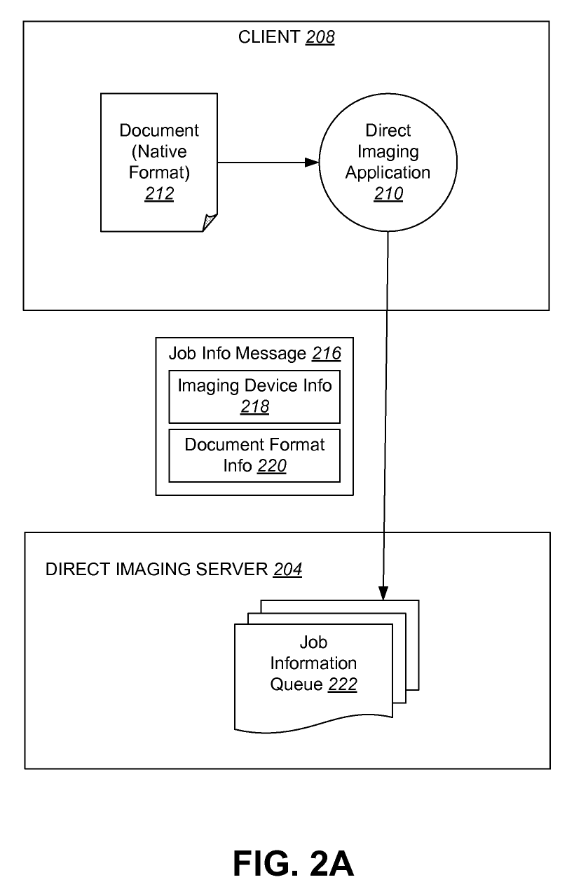

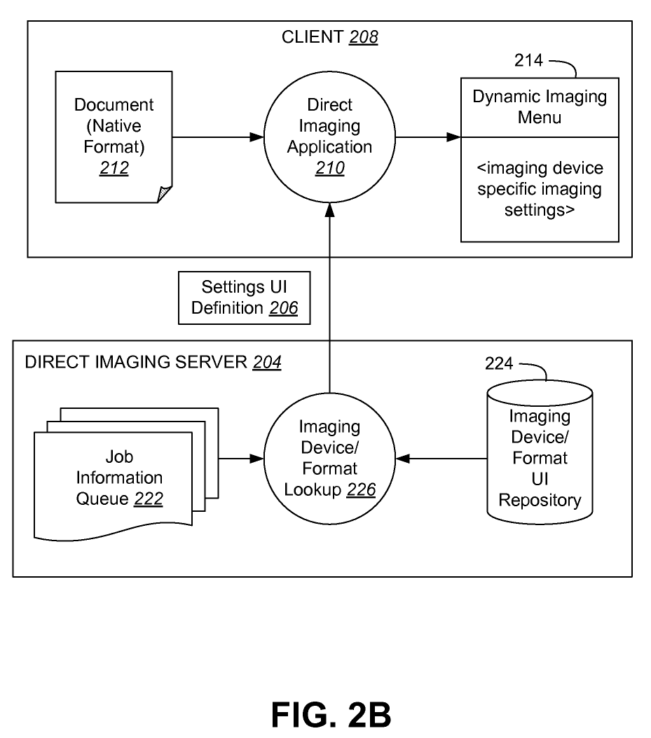

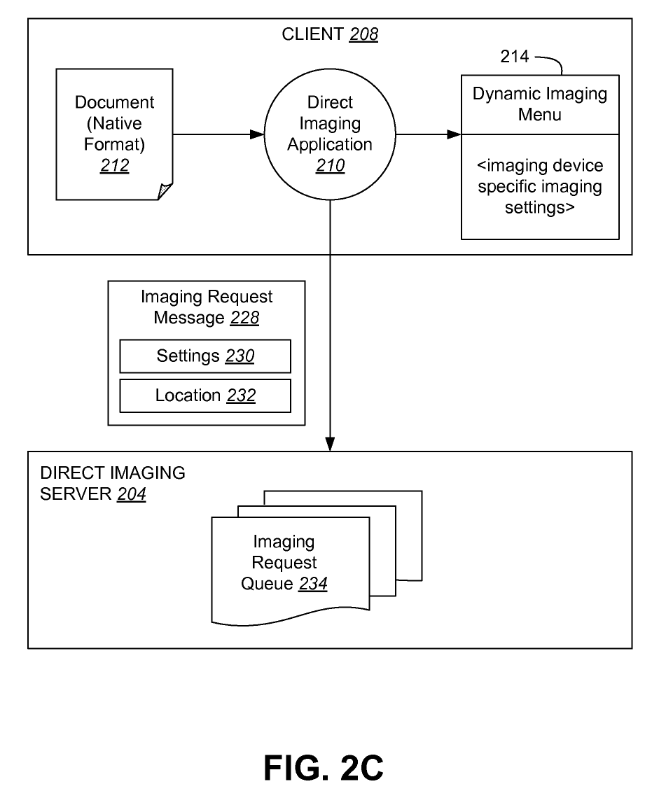

FIG. 2A illustrates a direct imaging application 210 sending a job information message 216 to a direct imaging server 204. As discussed above, in accordance with an embodiment, a user may operate a direct imaging application 210 to directly submit documents 212 in native formats to an imaging device 102. The direct imaging application 210 may include a settings dialog, which may allow a user to select one or more imaging devices 102 or imaging device types.

The imaging devices 102 or imaging device types may be identified by any means, such as: manual input by the user, discovery using a management discovery protocol (e.g., SNMP) or service discovery protocol (e.g., Web Services), accessing a device registration service (e.g. Printer Directory Service) to obtain a list of pre-registered devices, etc. In the later case, the device registration service may be hosted on one or more of the imaging devices 102 or on a computing device. If the device registration service is on a computing device, the direct imaging application 210 may access the service either by direct communication with the device registration service, or by indirect communication with the device registration service (e.g., by making the request to the imaging device 102, which may forward the request to the device registration service).

When the device registration service is on an imaging device 102, it may additionally be under the control of, or hosted by, a third party application. For example, the service may be a Java applet which the controlling application may download to the imaging device 102, and the imaging device 102 may run the Java applet as a guest process. In another example, the controlling application may register with the imaging device 102 which messages types it will process. Messages received by the imaging device 102 (e.g., a list of available imaging devices 102), which are handled by the controlling application, may then be forwarded to the controlling application for interpretation and action. The controlling application may then send the responses (e.g., the imaging device list) directly back to the direct imaging application 210. Alternatively, the controlling application may send the responses to the imaging device 102, which may then forward (and possibly reformat) the responses to the direct imaging application 210.

Once an imaging device selection list is available, the direct imaging application 210 may display a dialog for the user to select an imaging device 102 or imaging device type, or possibly even multiple imaging devices 102 or imaging device types (e.g., for cluster printing). The direct imaging application 210 may also include an input dialog for identifying which files to submit for imaging. The input dialog may be constructed by any means, such as a drag and drop zone, file name input, browse button, etc.

Once the user has identified the imaging device(s) 102 and file(s) to submit for imaging, the direct imaging application 210 may construct a job information message 216. The job information message 216 may include imaging device information 218 and document format information 220. The imaging device information 218 may include the selected imaging device(s) 102 or imaging device type(s). The document format information 220 may include the file formats of the document(s) 212 to submit for imaging. Alternatively, the job information message 216 may include the document format information 220, but may not include the imaging device information 218.

The job information message 216 may then be sent to the direct imaging server 204. In an alternative embodiment, the job information message 216 may be sent to the imaging device 102.

The job information message 216 may be in any suitable format and sent over any suitable communication channel. Communication between the direct imaging application 210 and the direct imaging server 204 (or imaging device 102) may be synchronous (e.g., TCP) or asynchronous (e.g., UDP). Examples of protocols that may be used include: XML data over a proprietary port, web service (SOAP/XML), HTML over HTTP, network file system (NFS), remote procedural call (RPC), file transfer protocol (FTP), email message, instant message (IM), etc.

Upon receipt of the job information message 216, the direct imaging server 204 (or imaging device 102) may perform some validation of the message 216, such as determining whether the message 216 is in a valid format, determining whether the identified imaging devices 102 and/or imaging device types are managed by the direct imaging server 204, etc.

If the message 216 is validated, the message 216 may be entered into a job information queue 222. Additionally, the direct imaging server 204 (or imaging device 102) may optionally send a confirmation of acceptance/rejection of the message 216 back to the direct imaging application 210. The confirmation message may be sent over the same communication channel that was used to receive the job information message 216, or it may be sent over a different communication channel. The confirmation message may be in the same format or in a different format than the job information message 216.

FIG. 2B illustrates a direct imaging application 210 receiving a settings UI definition 206 from a direct imaging server 204. As discussed above, in accordance with an embodiment, the direct imaging server 204 (or imaging device 102) may process job information messages 216 from a job information queue 222. The processing of these messages 216 may be asynchronous to the receiving of the messages 216. The direct imaging server 204 (or imaging device 102) may then construct a settings UI definition 206 that is specific to the specified imaging devices 102 or imaging device types and document formats.

To construct the settings UI definition 206, the direct imaging server 204 may query an imaging device/format UI repository 224. An imaging device/format lookup component 226 is shown in FIG. 2B. The imaging device/format lookup component 226 may implement the functionality of querying the imaging device/format UI repository 224. The repository 224 may include a prefabricated settings UI definition 206 per selected imaging device 102 or imaging device type. Alternatively, the repository 224 may include element information on the settings control, from which the direct imaging server 204 (or imaging device 102) may dynamically construct a settings UI definition 206.

If the job information message 216 identifies multiple non-identical imaging devices 102 or imaging device types, the direct imaging server 204 or UI repository 224 may then attempt to merge the UI definitions 206 together. For example, the UI definitions 206 may be combined by combining only the elements common to all the UI definitions 206 or a union of all the elements of all the UI definitions 206. Additionally, the controls in the UI definition 206 may be pruned or augmented based on the specified formats. That is, some formats may have format specific settings, and as a result these settings may be added to the UI definition 206. Alternatively, there may be some settings which are not supported for the specified format, and as a result these settings may be removed from the UI definition 206.

The UI definition 206 may be in any suitable format. Generally, the format is conducive to rendering a UI 214. Examples of formats that may be used include: XML, HTML, XUL (an XML user interface markup language), XAML (Microsoft Avalon based markup/rendering language), etc.

Once the UI definition 206 has been constructed, the direct imaging server 204 may then send the UI definition 206 to the direct imaging application 210. The UI definition 206 may be sent by any means, such as those described earlier.

In another embodiment, the direct imaging server 204 may be under the control of a third party controlling application. In this case, the controlling application may control the processing of job information messages 216 from the queue 222 (e.g., scheduling/priority). The controlling application may also dynamically validate the messages 216. The controlling application may also dynamically provide a UI definition repository 224.

In the case where there is a controlling application, the controlling application may be registered with the target imaging device 102 by any means, such as manual input through an administrative interface (e.g., key operator code on front panel or embedded web page), automatic registration by the controlling application through a programmatic registration interface on the device (e.g., SOAP, HTTP, proprietary protocol over TCP/IP, etc.), discovery of the controlling application by the target imaging device 102 by a service discovery protocol (e.g., SLP, SSDP, Salutation, WS-Discovery, Microsoft UPnP, Sun Jini, Bluetooth, etc.), and so forth. In some cases, registration of the controlling application may also be implemented by downloading a program that can execute on the target imaging device 102, such as an executable module that runs native in the target imaging device 102, or a machine independent program that runs within a guest operating system, such as a Java applet.

In an embodiment where the job information message 216 includes the file formats of the document(s) 212 to be imaged, but not the target imaging device(s) 102, the direct imaging server 204 may additionally perform a best-fit search to determine one or more candidate imaging devices 102. The best-fit search may be based on any suitable algorithm. For example, the best-fit search may be based on the presence of a function or a sub-unit. The job information message 216 may additionally include information on the imaging function (e.g., print, fax, file, scan, copy, convert, publish, display, etc.) and/or required sub-units (e.g., scanner, fax modem, filing storage, etc.). As another example, the best-fit search may be based on the availability of the imaging device 102 (e.g., idle vs. busy). The job information message 216 may additionally include information on the urgency of the job. As another example, the best-fit search may be based on the performance of the imaging device 102 (e.g., pages per minute, output resolution). The job information message 216 may additionally include information on the desired performance speed (or range) of the imaging device(s) 102. As another example, the best-fit search may be based on the locality of the imaging device 102 (either physical or logical, e.g., by department). The job information message 216 may additionally include information on the location of the client 208 or desired location of the imaging device(s) 102. As another example, the best-fit search may be based on access rights. The job information message 216 may include access rights information for identifying imaging device(s) 102 on which the user has the authority to execute the desired function (e.g., print, fax, etc).

FIG. 2C illustrates a direct imaging application 210 sending an imaging request message 228 to a direct imaging server 204. Upon receiving the UI definition 206, the direct imaging application 210 may render the settings UI 214 for display to the user. The user may then optionally select one or more imaging settings. Once the user has completed the selection of imaging settings, the user may continue the imaging job by selecting an imaging button, or other stimulus.

The direct imaging application 210 may then construct an imaging request message 228. The imaging request message 228 may include the user selections of imaging settings 230 for the imaging job, as received via the settings UI 214. The imaging request 228 may also include the location 232 of the document(s) 212 to be imaged. The location 232 of the document(s) to be imaged may be in any format that can be interpreted by the direct imaging server 204, such as a uniform resource identifier (URI), a globally unique universal identifier (GUID), a network file system path (NFS), a uniform resource locator (URL), etc. The direct imaging application 210 may then send the imaging request message 228 to the direct imaging server 204. The format and method of sending the message 228 to the direct imaging server 204 may be of any suitable means, such as those discussed earlier.

Upon receipt of the imaging request message 228, the direct imaging server 204 may perform some validation of the message 228. For example, the direct imaging server 204 may determine whether the format of the message 228 is valid. As another example, the direct imaging server 204 may determine whether the resources to perform the imaging job are available.

If the message 228 is validated, the direct imaging server 204 may enter the message 228 into an imaging request queue 234. Additionally, the direct imaging server 204 may optionally send a confirmation of acceptance/rejection of the message 228 back to the direct imaging application 210. The confirmation message may be sent over the same communication channel that was used to receive the imaging request message 228, or it may be sent over a different communication channel. The confirmation message may be in the same format or in a different format than the imaging request message 228.

If the imaging request message 228 is accepted, the acceptance message sent to the direct imaging application 210 may include additional information. For example, the acceptance message may indicate that the job is pending, estimate when the job will start processing, identify the imaging device(s) 102 that will process the job, etc.

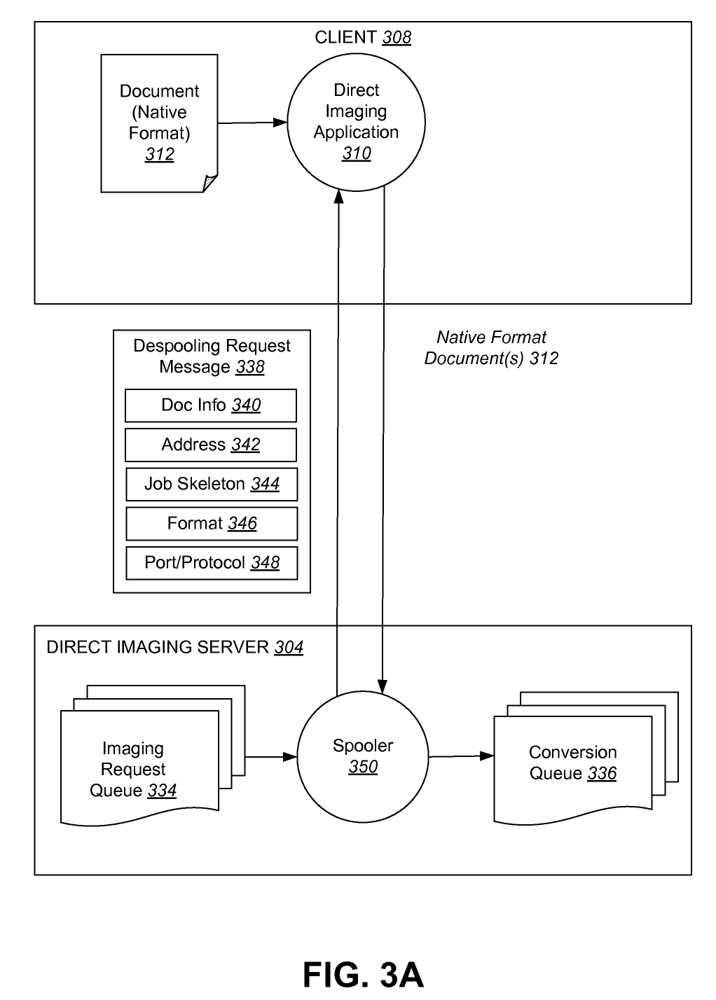

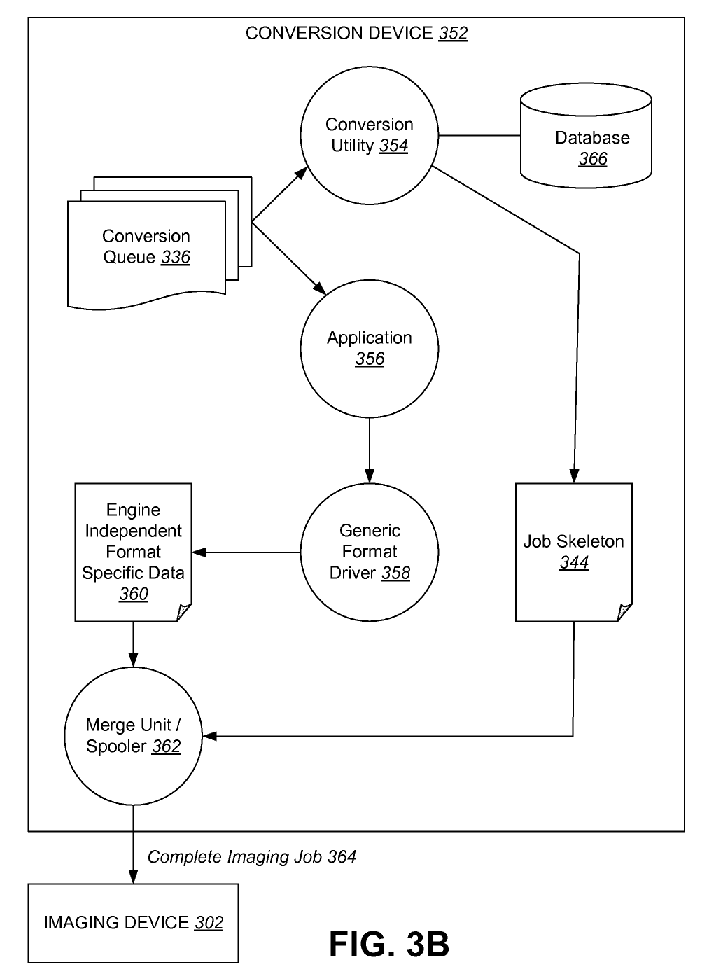

FIG. 3A illustrates a direct imaging server 304 sending a despooling request message 338 to a direct imaging application 310. As discussed above, in accordance with an embodiment, a direct imaging server 304 (or an imaging device 102) may process imaging requests 228 from an imaging request queue 334. The processing of these requests 228 may be asynchronous to the receiving of the requests 228. In another embodiment, the priority, scheduling and releasing of imaging request messages 228 for processing may be under the control of an external controlling application, as discussed earlier.

When the direct imaging server 304 starts processing an imaging request message 228, it may determine if any of the formats of the documents 312 in the request 228 are not supported as native formats to the target imaging device(s) 102. If not, the direct imaging server 304 may place an entry into a document conversion queue 336 to convert the non-native formatted document(s) 312 to a native format for the imaging request 228. The conversion request may include an identification of the document(s) 312 to convert, the format to convert to, where the converted data is to be returned, etc. The conversion request may also include other information.

In the case where the conversion process is on a device remote to the direct imaging server 304, the direct imaging server 304 may optionally place a conversion request to the remote device, and the remote device may place the conversion request on a conversion queue 336. The remote conversion device may be known by the direct imaging server 304 by any suitable means, such as manual input through an administrative interface (e.g., key operator code on front panel or embedded web page), automatic registration by the conversion device through a programmatic registration interface on the device (e.g., SOAP, HTTP, proprietary protocol over TCP/IP, etc.), discovery of the conversion device by the direct imaging server 304 by a service discovery protocol (e.g., SLP, SSDP, Salutation, WS-Discovery, Microsoft UPnP, Sun Jini, Bluetooth, etc.). The conversion request can be sent to the remote conversion device by any suitable means and format, such as those described earlier.

The direct imaging server 304 may then construct a job skeleton 344. The job skeleton 344 may include everything for a complete imaging job compatible with the targeted imaging device(s) 102, except for the document 312 (or converted document) data. Typically, the job skeleton 344 includes the following components: a command control sequence indicating the start of a job (e.g., UEL), a command control sequence specifying the job wide requirements (e.g., PJL, XPS PrintTicket), a placeholder for the document(s) 312 or document page(s), a command control sequence indicating the end of a job (e.g., UEL).

The direct imaging server 304 may construct the command control sequences by interpreting the settings 230 in the imaging request message 228 into a uniform set of imaging setting requirements. The uniform print setting requirements may then be converted to the device specific sequences using a database, such as a printer model database (PMDB). The printer model database is a database of printer control definitions for one or more models, instances or types of printers. Typically, the definitions contain a command control sequence for initiating and terminating a print job, a command control sequence for each corresponding uniform print option/setting pair, a command control sequence to identify the start of the page data and corresponding format. In one embodiment, the printer model database definitions may be directly downloaded from the imaging device(s) 102.

The direct imaging server 304 may then construct a despooling request message 338. A spooler 350 is shown in FIG. 3A. The spooler 350 may implement the functionality of constructing the despooling request message 338. The despooling request message 338 may include information 340 about the document(s) 312 to despool, and the communication address 342 (e.g., IP address) of the device to despool the document(s) 312 to. The despooling request message 338 may also include the imaging job skeleton 344, the format 346 to convert the data to, the port and/or protocol 348 to use for the despooling, etc. Where the document 312 is being despooled to a device other than the target imaging device 102 (e.g., if the communication address is a remote conversion device), the despooling request 338 may also include the communication address of the target imaging device 102.

In the case where the document 312 data is non-native to the target imaging device 102, the communication address 342 may be set to the device that will do the conversion (e.g., the direct imaging server 304 or a remote conversion device). If the communication address 342 is set to the direct imaging server 304, then the direct imaging server 304 may not send an imaging job skeleton 344, because the job skeleton 344 may already be resident on the direct imaging server 304. Likewise, the format 346 to convert to may also be known by the direct imaging server 304, and therefore the format 346 may not need to be sent either.

If the communication port and protocol 348 are predetermined (e.g., RAW 9100, HTTP/DIME), then the port and protocol 348 may not be specified in the despooling request message 338. Otherwise, the port and protocol 348 may be specified.

The direct imaging application 310, upon receiving the despooling request 338, may then initiate the despooling of the document(s) 312 to the specified communication address 342 using the specified, or default, port and protocol 348. If the despooling request 338 does not include a job skeleton 344, then the document(s) 312 may be sent as-is. Otherwise, the document(s) 312 may be embedded into the job skeleton 344 according to the location specified by the placeholders. The job skeleton 344 with the embedded document 312 data may then be sent to the specified communication address 342.

In other embodiments, the document 312 data may be sent with the job skeleton 344, but without embedding the document 312 data into the job skeleton 344. For example, the document 312 data may be appended to the job skeleton 344, with the placeholders updated accordingly. In another example, the document 312 data and job skeleton 344 may be sent as separate transmissions, with the placeholders updated accordingly.

FIG. 3B illustrates a conversion device 352 converting document 312 data. In the following discussion, it will be assumed that the conversion device 352 is performing the conversion. However, the direct imaging server 304 may alternatively perform the conversion.

When the document(s) 312 are despooled to the remote conversion device 352 for conversion, the conversion device 352 may initiate the conversion as follows. The document 312 data may be extracted from the despooled data. The format of each document 312 may be determined. The conversion device 352 may then determine if the conversion can be done by a direct format-to-format conversion. Otherwise, the conversion may be done by using a format specific application which supports the imaging of the document 312 data (i.e., is able to convert the native format of the document 312 into device independent graphical primitives, such as GDI in the Microsoft Windows® operating system).

When the conversion can be done by a direct format-to-format conversion, the extracted document 312 data may be passed to a conversion utility 354. The conversion utility 354 is shown in communication with a database 366, such as a printer model database (PMDB). The conversion utility 354 may use the database 366 in order to perform the format-to-format conversion. Once converted, the converted data may then be placed back into the job skeleton 344 at the appropriate location, according to the placeholders.

When the conversion is not done by a direct format-to-format conversion, the conversion may be done by loading the document 312 into an application 356 that supports the document 312 data and requesting that the application 356 does a background print of the document 312 to a specified logical imaging device.

The logical imaging device may include a format specific generic imaging device driver 358, which may convert the device independent graphical primitives (e.g., GDI) into the specified format (e.g., TIFF, PCL, etc.). The driver 358 may be referred to as a generic driver 358, because the driver 358 may be configured so that it does not generate any control sequences relating to how the target imaging device 302 will render and output (e.g., duplex, staple, etc.) the converted data.

Once converted, the converted data 360 may then be placed back into the job skeleton 344 at the appropriate location, according to the placeholders. A merge unit/spooler 362 is shown in FIG. 3B. The merge unit/spooler 362 may implement the functionality of placing the converted data 360 into the job skeleton 344. In an alternate embodiment, the merge unit/spooler 362 updates the placeholders with the location of the converted data (e.g., URL).

Once all the conversions are completed, the updated job skeleton 344 may be a complete imaging job 364, compatible with the target imaging device(s) 302. The conversion device 352 may then despool the complete imaging job 364 to the target imaging device(s) 302, according to the specified communication address 342 and port/protocol 348 of the imaging device(s) 302.

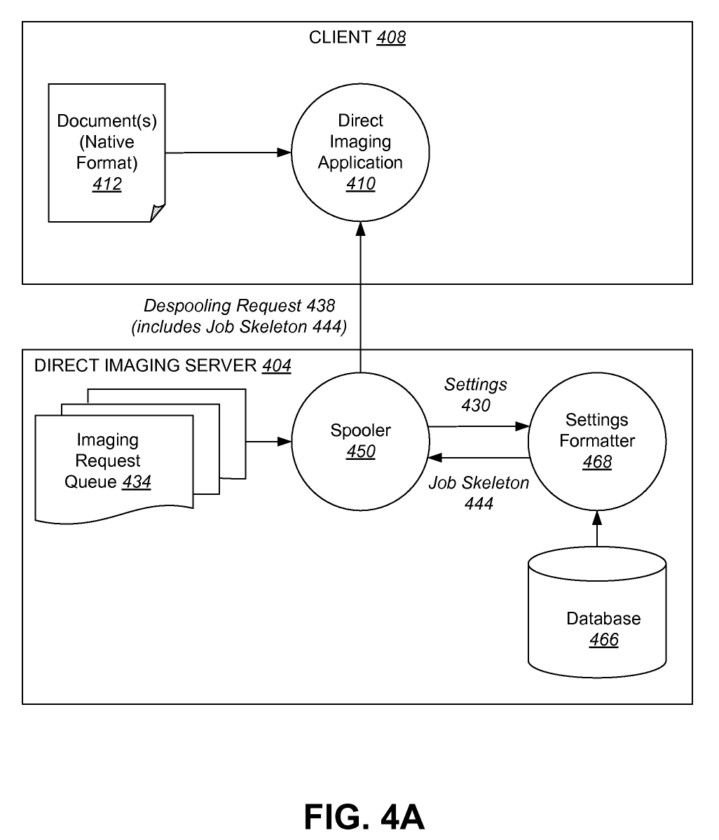

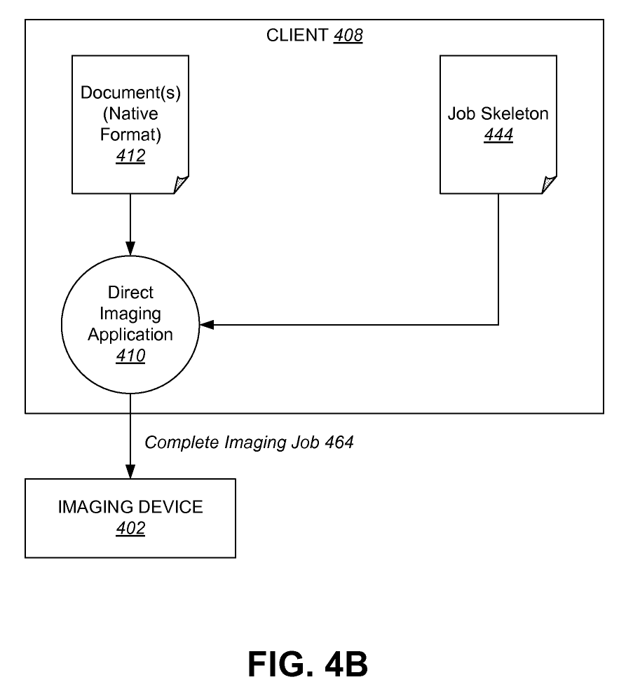

FIG. 4A illustrates a direct imaging server 404 sending a despooling request message 438 to a direct imaging application 410. As discussed above, in accordance with an embodiment, a direct imaging server 404 may process imaging requests 228 from an imaging request queue 434. In FIG. 4A, it is assumed that the direct imaging server 404 determines that the format of the document 412 data is supported by the target imaging device(s) 102. The direct imaging server 404 may construct a job skeleton 444 as described earlier. As part of constructing the job skeleton 444, the direct imaging server 404 may interpret the settings 430 in the imaging request message 228 into a uniform set of imaging setting requirements. A settings formatter 468 may implement this functionality. The settings formatter 468 is shown in communication with a database 466, such as a printer model database (PMDB). The settings formatter 468 may use the database 466 in order to interpret the settings 430 in the imaging request message 228 into a uniform set of imaging setting requirements.

The direct imaging server 404 may also construct a despooling request 438, and send the despooling request 438 to the direct imaging application 410 on the client 408. A spooler 450 is shown in FIG. 4A. The spooler 450 may implement the functionality of constructing the despooling request message 438 and sending the despooling request message 438 to the direct imaging application 410.

Where the format of the document 412 is supported by the imaging device 102, the components of the despooling request 438 may be constructed as follows. The communication address 342 may be set to the target imaging device(s) 102. The job skeleton 444 may be added to the despooling request 438. Additionally, if the imaging device 102 does not support the default port/protocol 348, or there is a more preferred method, the despooling request 438 may also include the port/protocol 348 to use to despool the completed imaging job.

FIG. 4B illustrates a direct imaging application 410 despooling a complete imaging job 464 to an imaging device 402. When the direct imaging application 410 receives the despooling request 438, when the document 412 format is native to the imaging device 402, the direct imaging application 410 may embed the document 412 data into the job skeleton 444, according to the placeholders. This may make a complete imaging job 464, which may be compatible with the target imaging device 402. In other words, the complete imaging job 464 may include settings that are specific to the imaging device 402. The complete imaging job 464 may also include document 412 data in its native format. The direct imaging application 410 may despool the complete imaging job 464 to the communication address 342 (i.e., imaging device 402) specified in the despooling request 438.

If a port/protocol 348 are specified, the direct imaging application 410 may despool the completed job using the specified port/protocol 348. Otherwise, the direct imaging application 410 may use the default port and protocol (e.g., RAW 9100).

The direct imaging server 404 may monitor or receive job status/completion notifications from the imaging device 402. If this occurs, the direct imaging server 404 may convert the notifications to a format that is compatible with the direct imaging application 410, and forward the converted job status/completion notifications to the direct imaging application 410.

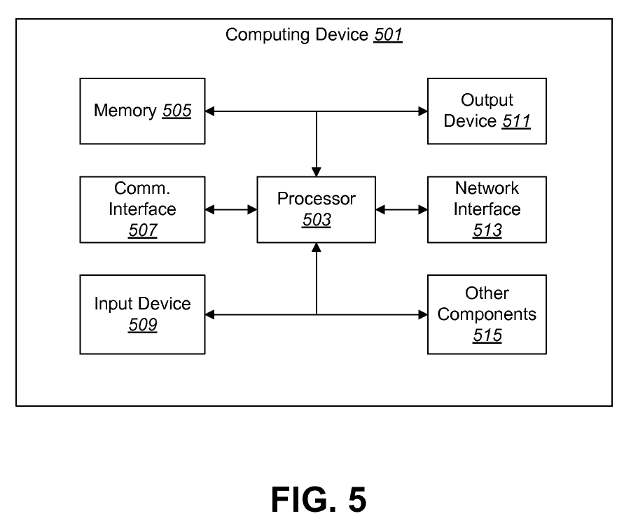

FIG. 5 illustrates various components that may be utilized in a computing device 501. An imaging device 102, client device 108, direct imaging server 104 and conversion device 352 are all examples of computing devices 501. The illustrated components may be located within the same physical structure or in separate housings or structures.

The computing device 501 is shown with a processor 503 and memory 505. The processor 503 may control the operation of the computing device 501 and may be embodied as a microprocessor, a microcontroller, a digital signal processor (DSP) or other device known in the art. The processor 503 typically performs logical and arithmetic operations based on program instructions stored within the memory 505. The instructions in the memory 505 may be executable to implement the methods described herein.

The computing device 501 may also include one or more communication interfaces 507 and/or network interfaces 513 for communicating with other electronic devices. The communication interface(s) 507 and the network interface(s) 513 may be based on wired communication technology, wireless communication technology, or both.

The computing device 501 may also include one or more input devices 509 and one or more output devices 511. The input devices 509 and output devices 511 may facilitate user input. Other components 515 may also be provided as part of the computing device 501.

FIG. 5 illustrates only one possible configuration of a computing device 501. Various other architectures and components may be utilized.

The embodiments disclosed herein may be applicable to the printing/imaging subsystems of a wide variety of operating systems, such as the Microsoft Windows operating system, Apple MacIntosh Operating System, Linux Operating System, System V Unix Operating Systems, BSD Unix Operating Systems, OSF Unix Operating Systems, IBM Mainframe MVS Operating System, IBM AS/400, etc.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules, circuits and algorithm steps described in connection with the embodiments disclosed herein may be implemented as electronic hardware, computer software or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limiting the scope of the claims.

The various illustrative logical blocks, modules and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the embodiments disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

While specific embodiments have been illustrated and described, it is to be understood that the claims are not limited to the precise configuration and components illustrated above. Various modifications, changes and variations may be made in the arrangement, operation and details of the embodiments described above without departing from the scope of the claims.

What is claimed is:

1. A method for driverless imaging of documents, comprising:
a direct imaging application on a client sending an imaging request message to another device, wherein the imaging request message corresponds to an imaging job to be performed on a target imaging device;
in response to receiving the imaging request message, the device creating an imaging job skeleton, wherein the imaging job skeleton is compatible with the target imaging device, and wherein the imaging job skeleton comprises contents of a complete imaging job other than document data;
the device sending a despooling request to the direct imaging application, wherein the despooling request indicates where the document data corresponding to the imaging job should be despooled; and
in response to receiving the despooling request, the direct imaging application despooling the document data in accordance with the despooling request.

2. The method of claim 1, wherein the device that creates the imaging job skeleton and that sends the despooling request is a direct imaging server.

3. The method of claim 1, wherein the device that creates the imaging job skeleton and that sends the despooling request is the target imaging device.

4. The method of claim 1, wherein the despooling request comprises the imaging job skeleton, and further comprising the direct imaging application merging the document data into the imaging job skeleton.

5. The method of claim 1, wherein if the format of the document data is native to the target imaging device, the despooling request indicates that the document data should be despooled to the target imaging device.

6. The method of claim 1, wherein if the format of the document data is not native to the target imaging device, the despooling request indicates that the document data should be despooled to a conversion device.

7. The method of claim 6, wherein the conversion device is a direct imaging server.

8. The method of claim 6, wherein the conversion device is another device other than a direct imaging server.

9. The method of claim 6, further comprising:
a conversion device converting the document data into a format that is compatible with the target imaging device; and
the conversion device despooling the converted document data to the target imaging device.

10. The method of claim 1, further comprising the direct imaging application receiving user selections of imaging settings for the imaging job via a settings user interface.

11. The method of claim 10, wherein the imaging request message comprises the imaging settings, and wherein creating the imaging job skeleton comprises converting the imaging settings in the imaging request message into command control sequences that are specific to the target imaging device.

12. The method of claim 11, further comprising:
the direct imaging application sending a job information message to the device;
in response to receiving the job information message, the device sending a settings user interface definition to the direct imaging application; and
the direct imaging application generating and displaying the settings user interface based on the settings user interface definition.

13. A client device that is configured to effect driverless imaging of documents, the client device comprising:
a processor;
memory in electronic communication with the processor;
instructions stored in the memory, the instructions being executable to:
send an imaging request message to another device, wherein the imaging request message corresponds to an imaging job to be performed on a target imaging device;
receive a despooling request from the device, wherein the despooling request indicates where document data corresponding to the imaging job should be despooled; and
in response to receiving the despooling request, despool the document data in accordance with the despooling request.

14. The client device of claim 13, wherein the despooling request comprises an imaging job skeleton, wherein the imaging job skeleton is compatible with the target imaging device, wherein the imaging job skeleton comprises contents of a complete imaging job other than the document data, and wherein the instructions are also executable to merge the document data into the imaging job skeleton.

15. The client device of claim 13, wherein if the format of the document data is native to the target imaging device, the despooling request indicates that the document data should be despooled to the target imaging device.

16. The client device of claim 13, wherein if the format of the document data is not native to the target imaging device, the despooling request indicates that the document data should be despooled to a conversion device.

17. The client device of claim 13, wherein the instructions are also executable to receive user selections of imaging settings for the imaging job via a settings user interface.

18. A device that is configured to facilitate driverless imaging of documents, the device comprising:
a processor;
memory in electronic communication with the processor;
instructions stored in the memory, the instructions being executable to:
receive an imaging request message from a client, wherein the imaging request message corresponds to an imaging job to be performed on a target imaging device;
in response to receiving the imaging request message, create an imaging job skeleton, wherein the imaging job skeleton is compatible with the target imaging device, and wherein the imaging job skeleton comprises contents of a complete imaging job other than document data; and
send a despooling request to the direct imaging application, wherein the despooling request indicates where the document data corresponding to the imaging job should be despooled.

19. The device of claim 18, wherein the device is a direct imaging server.

20. The device of claim 18, wherein the device is the target imaging device.
